(19) United States
(12) Patent Application Publication
(10) Pub. No.: US 2009/0210613 A1
(43) Pub. Date: Aug. 20, 2009

(54) Method for Programming a Controller in a Motor Vehicle

(75) Inventors: Stefan Mueller, Haar-Gronsdorf (DE); Marc Torlo, Kirchheim (DE)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke Aktiengesellschaft, Muenchen (DE)

(21) Appl. No.: 12/371,322

(22) Filed: Feb. 13, 2009

Related U.S. Application Data
(63) Continuation of application No. PCT/EP2007/006872, filed on Aug. 3, 2007.

(30) Foreign Application Priority Data
Aug. 17, 2006 (DE) 10 2006 038 428.8

(51) Int. Cl. G06F 12/00

(52) U.S. Cl. 711/103; 711/154; 711/E12.001

(57) ABSTRACT

A method and apparatus are provided for programming of a control device of a motor vehicle, in which the control device includes at least one program-controlled processor and at least two individually addressable memory areas, in particular at least two physically separated memory components. In order to accelerate the inputting of memory contents the invention suggests that the processor carries out or brings about the following two steps at least intermittently largely simultaneously. On the one hand, checking whether programs, program parts and/or data already written into the first memory area correspond to the data to be written into the first memory area, and on the other hand, writing a program, a program part and/or data into the second memory area.

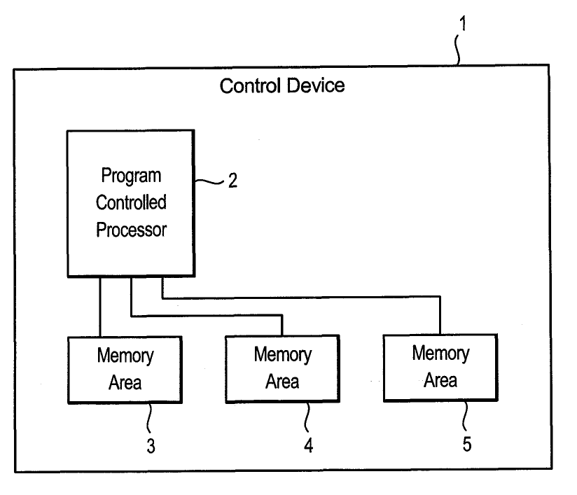

### CROSS REFERENCE TO RELATED APPLICATIONS

This application is a continuation of PCT International Application No. PCT/EP2007/006872, filed Aug. 3, 2007, which claims priority under 35 U.S.C. § 119 to German Patent Application No. 10 2006 038 428.8, filed Aug. 17, 2006, the entire disclosures of which are herein expressly incorporated by reference.

### BACKGROUND AND SUMMARY OF THE INVENTION

The invention relates to a process for the programming of a control device of a motor vehicle.

In current control devices in motor vehicles so-called flash components and/or flash EEPROMs are used to eliminate errors and the subsequent adaptation of software. The inputting of an amount of information lasts distinctly longer in these flash components than the reading out of the same amount of information. Since the functions to be carried out by the control devices by means of program-controlled processors are becoming more and more complex, the program controls and the software of the control devices and the data, such as characteristic fields, to be saved in the control device require more and more storage space. This increasing storage space can be made available in that, instead of one memory component, two or more memory components are implemented in the control device. The two or more memory components are sequentially written with programs, program parts and/or data.

If a software update is required in one or more control devices in the vehicle, e.g., in the workshop, the inputting of the software into the memory components takes a rather long time, which makes the stay in the workshop expensive.

The present invention solves the problem in particular of making a process available for the programming of a control device of a motor vehicle in which the inputting of memory content takes place more rapidly.

Other objects, advantages and novel features of the present invention will become apparent from the following detailed description of one or more preferred embodiments when considered in conjunction with the accompanying drawings.

### BRIEF DESCRIPTION OF THE DRAWINGS

The figure illustrates a schematic representation of an exemplary embodiment of a control device of a motor vehicle, in accordance with the present invention.

### DETAILED DESCRIPTION OF THE DRAWINGS

As illustrated in the figure, a control device 1 of a motor vehicle includes a program-controlled processor 2 and a plurality of memory areas 3, 4 and 5.

An aspect of the invention is that the processor carries out or brings about the following two steps at least intermittently and largely simultaneously. They are, on the one hand, checking whether programs, program parts and/or data already written into the first memory area correspond to the data to be written into the first memory area, and, on the other hand, writing a program, a program part and/or data into the second memory area.

During the writing into a memory area, the processor of the control device is as a rule not completely loaded with this process. The resources of the program-controlled processor that are still available and were previously unused can be used in accordance with the invention in order to also write into the second memory area and, if necessary, into the first and the second memory component in addition to the first memory area. Exemplary embodiments of the invention provide that after the conclusion of the writing process on the second memory area while the writing process has not yet been concluded on the first memory area, a check is made using the unused resources of the program-controlled processor whether the programs, program parts and/or data actually inputted into the second memory area are identical to the programs, program parts and/or data provided for the inputting.

The performing of this checking only after the conclusion of the writing procedures into the two or more memory areas is known, that is, considerable resources of the program-controlled processor of the particular control device lie “fallow” for a long time, and during the later checking whether the data was correctly inputted into the memory areas the load on the processor rises so considerably that the checking and therewith the entire writing process lasts undesirably long. The programming procedure of control devices with two and more individually addressable memory areas and memory components can be distinctly accelerated by the shifting, in accordance with the invention, of tasks heavily loading the processor into a temporary phase of low loading of the processor. In addition, the programming procedure becomes more stable and therewith more reliable on the whole as a result.

In an embodiment of the invention a check is made using the known CRC process (cyclic redundancy check) whether data already written into the first memory area corresponds to the data to be written into the first memory area. A deviation as a consequence of a technical disturbance during the transfer or the inputting of the data can be recognized by the CRC process.

In another embodiment a check is made, as a supplement to the CRC process, whether the data was falsified or changed during the transfer and/or during the inputting into the memory area. This takes place in accordance with the invention using the known comparison of the hash value of the data to be written with the hash value of the actually written data. In a further development of the invention, the agreement is carried out on the basis of a known signature process in which a theoretical hash value coded with a secret key is decoded with the public key complementary to the secret key (public key process) and the decoded theoretical hash value is compared with the actual hash value of the inputted data.

The public key process or another coding process places especially high requirements on the program-controlled processor of the control device and ensures especially long programming times in the known programming process. These times can be significantly shortened by using the teaching of the invention.

In an embodiment of the invention a check is made on the basis of the signature process whether the data written into the particular memory area corresponds to the data to be written into the particular memory area. In this embodiment the data is considered as not manipulated if the data in each of the memory areas corresponds, taken by itself, to the data to be written.

In another embodiment of the invention a check is made on the basis of the signature process whether the data written into the particular memory area corresponds to the data to be written into the particular memory area, and a check is made using a further signature checking step whether the entirety of the data in the two or more memory areas deviates from the entirety of the data to be written.

In an embodiment of the invention a check is made within the framework of the signature process whether the hash value and/or the signature for the programs, program parts and/or data actually written into the first memory area coincides with the hash value and/or with the signature for the programs, program parts and/or data to be written into the first memory area.

In another embodiment of the invention the hash value and/or the signature for the programs, program parts and/or data actually written into the first memory area is/are determined, and furthermore the hash value and/or the signature for the programs, program parts and/or data actually inputted into the second memory area is/are determined. The two hash values and/or signatures are combined and the combined hash value and/or the combined signature is/are compared with a single hash value and/or a single signature.

The memory areas in accordance with the invention may be two or more individually addressable non-volatile flash EEPROMs.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for programming a control device of a motor vehicle, in which the control device includes at least one program-controlled processor and at least two individually addressable memory areas that are physically separated memory components, the method comprising the acts of:
checking whether at least one of programs, program parts and data already written into a first memory area correspond to data to be written into the first memory area; and
writing at least one of a program, a program part and data into a second memory area,
wherein the checking and writing acts are performed intermittently and largely simultaneously by the processor.

2. The method according to claim 1, wherein the checking whether data already written into the first memory area corresponds to the data to be written into the first memory area takes place using a cyclic redundancy check process.

3. The method according to claim 1, wherein the checking whether data already written into the first memory area corresponds to the data to be written into the first memory area takes place using a comparison of a hash value of the data to be written with a hash value of the actually written data.

4. The method according to claim 1, wherein the checking whether data already written into the first memory area corresponds to the data to be written into the first memory area takes place using a signature process.

5. The method according to claim 4, wherein a check is made based on the signature process whether the data written into the second memory area corresponds to the data to be written into the second memory area.

6. The method according to claim 4, wherein a check is made within a framework of the signature process whether a hash value or the signature for the at least one of the programs, program parts and data actually written into the first memory area coincides with the hash value or with the signature for the at least one of programs, program parts and/or data to be written into the first memory area.

7. The method according to claim 4, wherein a check is made within a framework of the signature process whether a hash value or the signature for the at least one of the programs, program parts and data actually written into the second memory area coincides with the hash value or with the signature for the at least one of the programs, program parts and data to be written into the second memory area.

8. The method according to claim 6, wherein a coincidence is considered as given for the first and second memory areas if the hash value or the signature for the first and second memory areas was determined to be coinciding.

9. The method according to claim 4, wherein a hash value or the signature for the at least one of the programs, program parts and data actually written into the first memory area is determined, the hash value or the signature for the at least one of the programs, program parts and data actually inputted into the second memory area is determined, the two hash values or signatures are combined, and the combined hash value and the combined signature is compared with a single hash value and a single signature.

10. The method according to claim 1, wherein the first memory area and the second memory area are made available by a non-volatile electronic memory.

11. The method according to claim 10, wherein the non-volatile memory is a flash EEPROM.

12. A control device of a motor vehicle, comprising:
a program-controlled processor; and
a plurality of individually addressable memory areas that are physically separated memory components, wherein
the processor is configured to check whether at least one of programs, program parts and data already written into a first memory area correspond to data to be written into the first memory area, and
the processor is configured to write at least one of programs, program parts and data into a second memory area.

13. A computer-readable medium encoded with a computer program for programming a control device of a motor vehicle, in which the control device includes a program-controlled processor and a plurality of individually addressable memory areas that are physically separated memory components, the computer program comprising instructions for:
checking whether at least one of programs, program parts and data already written into a first memory area correspond to data to be written into the first memory area; and
writing at least one of a program, a program part and data into a second memory area,
wherein the checking and writing instructions are performed intermittently and largely simultaneously by the processor.

14. The computer-readable medium according to claim 13, wherein the checking whether data already written into the first memory area corresponds to the data to be written into the first memory area takes place using a cyclic redundancy check process.

15. The method according to claim 2, wherein the checking whether data already written into the first memory area corresponds to the data to be written into the first memory area takes place using a comparison of a hash value of the data to be written with a hash value of the actually written data.

16. The method according to claim 2, wherein the checking whether data already written into the first memory area corresponds to the data to be written into the first memory area takes place using a signature process.

17. The method according to claim 5, wherein a check is made within a framework of the signature process whether a hash value or the signature for the at least one of the programs, program parts and data actually written into the first memory area coincides with the hash value or with the signature for the at least one of programs, program parts and/or data to be written into the first memory area.

18. The method according to claim 5, wherein a check is made within a framework of the signature process whether a hash value or the signature for the at least one of the programs, program parts and data actually written into the second memory area coincides with the hash value or with the signature for the at least one of the programs, program parts and data to be written into the second memory area.

19. The method according to claim 7, wherein a coincidence is considered as given for the first and second memory areas if the hash value or the signature for the first and second memory areas was determined to be coinciding.

20. The method according to claim 5, wherein a hash value or the signature for the at least one of the programs, program parts and data actually written into the first memory area is determined, the hash value or the signature for the at least one of the programs, program parts and data actually inputted into the second memory area is determined, the two hash values or signatures are combined, and the combined hash value and the combined signature is compared with a single hash value and a single signature.
